(19) United States
(12) Patent Application Publication
(10) Pub. No.: US 2006/0118149 A1
(43) Pub. Date: Jun. 8, 2006

(54) Slide out pressure washer system

(75) Inventors: Nick Benson, Knoxville, TN (US); Perry G. Benson, Powell, TN (US)

Correspondence Address: PITTS AND BRITTIAN P C, P O BOX 51295, KNOXVILLE, TN, 37950-1295, US

(73) Assignee: Benson Enterprises, Knoxville, TN (US)

(21) Appl. No.: 11/005,255

(22) Filed: Dec. 6, 2004

(51) Int. Cl. B08B 3/00; B08B 3/12; B08B 3/04

(52) U.S. Cl. 134/123; 134/198; 134/172

(57) ABSTRACT

A combination pressure washer unit and slide out tray assembly for a carriage such as a bus, trailer or the like which transports racing cars or other equipment needing a pressure wash after use. The system includes a slide out tray assembly that is mounted in a compartment on the side of the carriage. A low profile pressure washer is mounted on the tray assembly floor and can be readily accessed through the compartment opening, slid out for use, and returned to its stowed position within the side of the carriage after use for transport.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a pressure washer system and more particularly a combination pressure washer unit and slide out tray system for a carriage such as a bus, recreational vehicle, trailer or the like which carries racing cars or other equipment needing a pressure wash after use. The system could also be used to wash the carriage within which it is showed.

2. Description of the Related Art

Pressure washer systems are well known and commonly used for cleaning race cars, heavy equipment or the like which need cleaning after use. It is desirable to have the pressure washer unit at the race track or other site of use such that it can be conveniently cleaned between races or immediately thereafter. Transportation of pressure washer units to a race track, or to other sites of equipment use, normally has required the use of the bed of a pickup truck or a dedicated trailer for hauling the pressure washers. These methods of transporting the pressure washer may also require a second vehicle and may require a separate driver thereby increasing the expense and inconvenience of the onsite washing operation.

Known prior art typical to the fields of this invention is shown in the following U.S. Pat. Nos. 4,697,464; 5,086,975; 5,238,191; 5,299,767; 5,421,520; 5,529,460; 5,582,728; 5,706,548; 5,713,310; 5,745,043; 5,954,494; 5,964,409; 5,979,788; 6,092,998; 6,571,805; 6,648,603; 6,680,001; 6,761,135; 6,779,745; and 6,779,987.

Accordingly, it is desirable to have a combination pressure washer unit and slide out tray system that can be readily mounted on the side of a carriage such as a bus or trailer that transports racing cars or other equipment.

### BRIEF SUMMARY OF THE INVENTION

A combination pressure washer unit and slide out tray system for a carriage such as a bus, trailer or the like which transports racing cars or other equipment needing a pressure wash after use. This system includes a compartment defined by walls opening onto the side of the carriage. This compartment opening may be covered by a suitable door preferably pivotally mounted on one side of the carriage. A slide out tray assembly is mounted in the compartment and accessible through the opening. The slide out tray system has a pair of slide assemblies, each having one end mounted on a side wall of the compartment and a tray floor carried by the slide assemblies. A low profile pressure washer unit is mounted on the tray and can be readily accessed through the compartment opening and stowed after use for transport.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a combination pressure washer unit and slide out tray system mounted on the side of a carriage which in the illustrated embodiment comprises a bus;

FIG. 2 is a perspective view of the combination pressure washer unit and slide out tray system separated from the carriage for purposes of illustration;

FIG. 3 is a side elevation view of the combination pressure washer unit and slide out tray system show in FIG. 2;

FIG. 4 is a plan view of the system shown in FIG. 3; and

FIGS. 5a and 5b illustrate the lock members for securing the slide out tray in position for storage and transportation.

### DETAILED DESCRIPTION OF THE INVENTION

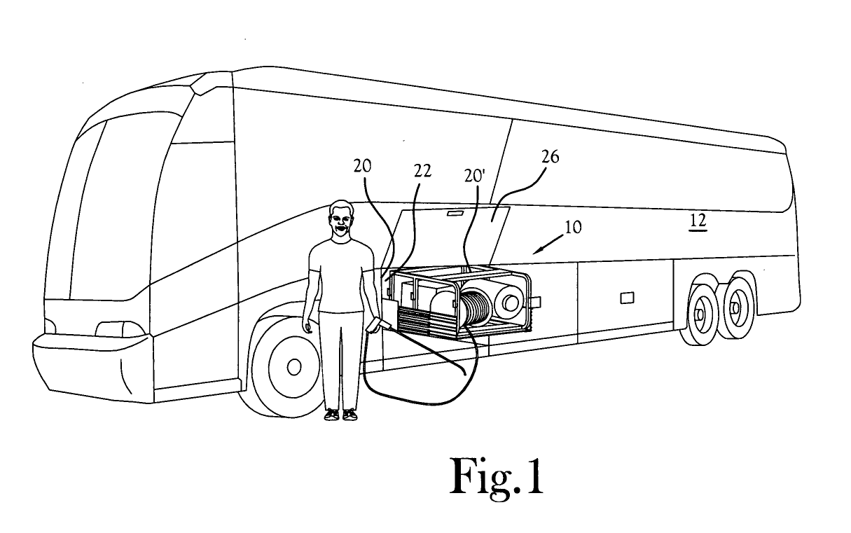

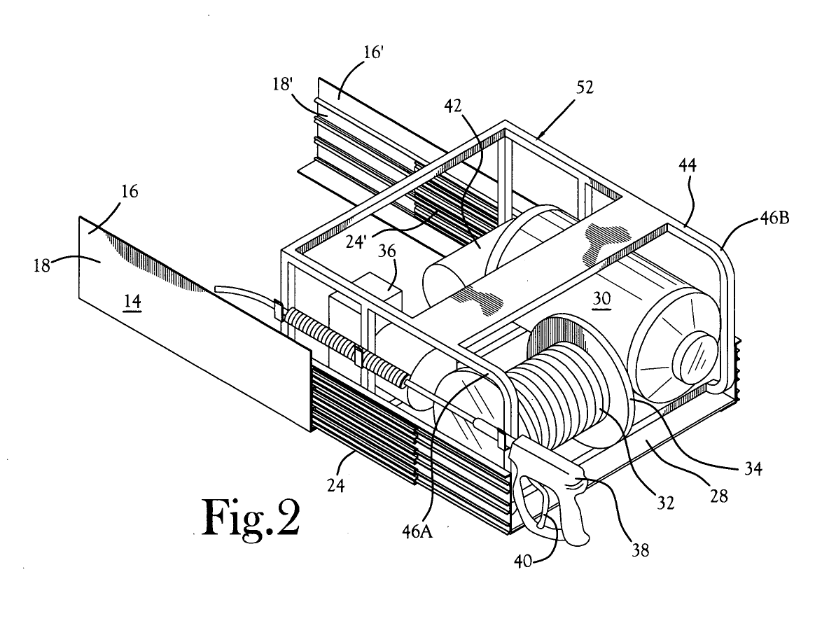

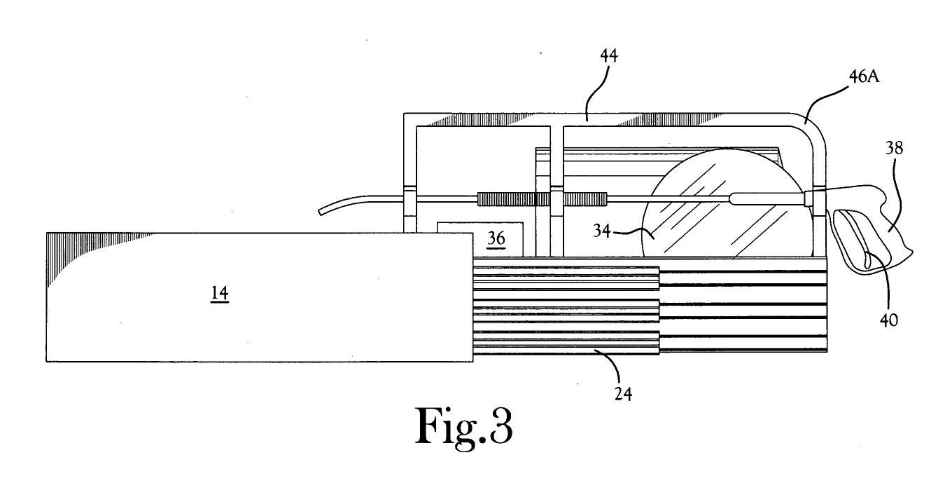

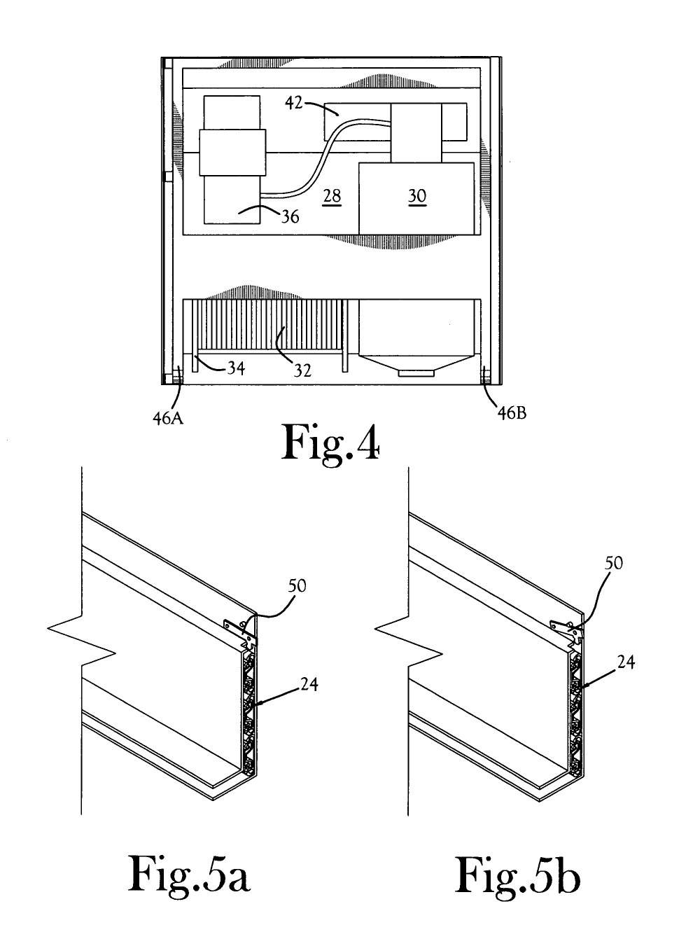

A combination pressure washer and slide out tray system is generally indicated at 10. This system is suitable for being mounted on the side of a carriage 12 such as a bus, trailer or the like which transports racing cars or other equipment needing a pressure wash after use. The system 10 includes a slide out tray assembly 14 as shown in the FIGS. 2 and 3. This slide out tray assembly includes a pair of slide members 16 and 16′ each having respective ends 18 and 18′ mounted on the juxtaposed sidewalls 20 and 20′, respectively, of the compartment 22 accessible through the opening defined in the side of the carriage as is shown in FIG. 1. The slide members 16 and 16′ include slides 24 and 24′, respectively, of conventional design that are suitable for sliding within the tracks defined in the telescoping slide members. Preferably, sliding is facilitated by a conventional roller bearings or the like. The slides are of a strength to support the washer unit which may weigh 500 pounds or more. Moreover, the slides telescope as is shown in FIG. 2 to provide suitable clearance, if desired, from the side of the carriage as is shown in FIG. 1. It will be noted in FIG. 2 that the slide out tray assembly includes a tray floor 28. This floor is connected along each of its sides in the preferred embodiment to the slides 24 and 24′ proximate the lower portions thereof.

In the illustrated embodiment, a suitable door 26 is pivotally mounted on the side of the carriage 12 for selectively opening and closing the compartment 22 which receives the combination pressure washer and slide out tray system when it is stowed.

A pressure washer unit is mounted on the tray floor 28 as is shown in FIGS. 1 and 2. This pressure washer unit is designed to be a low profile unit to reduce the size of the compartment 22 in the side of the carriage 12. To this end, the burner assembly 30 is positioned in a horizontal location for a heated pressure washer unit. The burner assembly 30 is of substantially conventional design and includes a heat coil assembly that heats water supplied from an outside source such as a faucet prior to the introduction of that water into the hose 32 carried on the reel 34 which is also mounted on the tray floor 28. It will be noted that water forced from the outside source by the pump 36 reaches the nozzle assembly 38 and is selectively discharged in conventional manner by depression of the nozzle release 40. The burner 42 is connected to the burner assembly 30 and supplies heat for heating the heat coils of conventional design contained within the burner assembly 30. In certain applications, a cold system provides suitable cleaning capability, and the burner assembly 30 can be eliminated. In this cold system application the outside water is supplied directly into the pump 36 before being pressurized and fed into the hose 32 for discharge through the nozzle assembly 38.

Because of the weight of the pressure washer, the tray is provided with suitable framework 44 which enhances the strength of the tray and provides ready means for gripping the tray to slide it from the compartment 22 when it is desirable to perform a pressure washing operation. This framework includes arcuate frame members 46a and 46b which enhance the strength of the tray by forming tray superstructure 52 and provide ready handles for sliding movement of the tray laden with the pressure washer components. The members of the superstructure 52 shown in FIG. 2 also provide stability and rigidity for the tray floor 28.

When the combination pressure washer and slide out tray assembly is moved to a closed position, it is preferably locked in such position through operation of the lock members 50 shown in FIGS. 5a and 5b. Referring specifically to FIG. 5a, the locking member 50 is pivoted into a locking position such that the slide assemblies 24 cannot telescope outwardly thereby preventing outward movement of the system during transport. When the unit is to be used, the system is slid from its stowed position to the position shown in FIG. 1 by releasing the lock 50 as is shown in FIG. 5b, which allows the tray to be moved from the compartment 22 in the side of the carriage 12 for use. As is necessary and desired, a suitable lock can be used to secure the combination pressure washer and slide out tray system in the open position such that it will not inadvertently slide back into the compartment during use.

From the foregoing detailed description, it will be recognized by those skilled in the art that a combination pressure washer and slide out tray system has been provided which can be readily stored in the side of a carriage, such as bus or trailer, suitable for hauling a racing car or the like. The pressure washer unit is designed to have a low profile such that the compartment within which it fits during stowage is of a reduced size particularly in the vertical direction. The unit can be readily slid out by an operator to move it to a position for use and returned to the stowed position to transport. Moreover, the telescoping slide assemblies carrying the tray floor 28 increase the distance of travel of the tray thereby enhancing the accessibility to the pressure washer by a user.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, We claim:

1. A combination pressure washer unit and slide out tray system for a carriage such as a bus, trailer or the like which transports racing cars or other equipment needing a pressure wash on location after use, said system including:
a compartment defined by walls in said carriage and having an opening on one side thereof;
a slide out tray assembly mounted in said compartment and accessible through said opening, said slide out tray assembly including a pair of slide assemblies each having one end mounted on a side wall of said compartment and a tray floor carried by said pair of slide assemblies;
a pressure washer unit mounted on the tray floor whereby said pressure washer unit can be accessed through said compartment opening, slid out for use and returned to its stowed position within the side of said carriage for transportation after use.

2. The apparatus of claim 1 wherein each of the slide assemblies is carrying the tray floor, telescope to increase the distance of travel of the tray floor thereby enhancing the accessibility of the pressure washer by a user.

3. The apparatus of claim 1 wherein said tray assembly includes a superstructure which enhances the strength of the tray and further enables it to carry the pressure washer mounted thereon.

4. The system of claim 1 wherein said pressure washer unit includes a burner assembly mounted horizontally upon the tray thereby reducing the vertical dimension of the carriage compartment necessary for stowing said system.

5. The system of claim 3 wherein said tray superstructure includes at least one arcuate member which serves as a handle for gripping and sliding the tray to a desired location.

6. The system of claim 1 including at least one lock member for securing the telescoping slide assembly in a closed position upon stowing the tray for transport by the carriage.

7. A combination pressure washer unit and slide out tray system for a carriage such as a bus, trailer or the like which transports racing cars or other equipment needing a pressure wash on location after use, said system including:
a compartment defined by walls in said carriage and having an opening on one side thereof;
a slide out tray assembly mounted in said compartment and accessible through said opening, said slide out tray assembly including a pair of slide assemblies each having one end mounted on a side wall of said compartment and a tray floor carried by said pair of slide assemblies wherein each of the slide assemblies carrying the tray floor telescope to increase the distance of travel of the tray floor thereby enhancing the accessibility of the pressure washer by a user and a tray floor carried by said pair of side slide assemblies, said tray assembly having a superstructure which enhances the strength of the tray and further enables the tray to carry the pressure washer mounted thereon, wherein said tray superstructure includes at least one arcuate member which serves as a handle for gripping and sliding the tray to a desired location;
a pressure washer unit mounted on the tray floor whereby said pressure washer unit can be accessed through said compartment opening, slid out for use and returned to its stowed position within the side of said carriage for transportation after use.

8. The system of claim 7 wherein said pressure washer unit includes a burner assembly mounted horizontally upon the tray thereby reducing the vertical dimension required for stowing said system in the carriage compartment.

9. The system of claim 7 including at least one lock member for securing the telescoping slide assembly in a closed position upon stowing the tray for transport by the carriage.

10. A combination pressure washer unit and slide out tray system for a carriage such as a bus, trailer or the like which transports racing cars or other equipment needing a pressure wash after use, said carriage defining a compartment having walls and an opening on one side thereof including:
a slide out tray assembly mounted in said compartment and accessible through said opening, said slide out tray assembly including a pair of slide assemblies each having one end mounted on a side wall of said compartment and a tray floor carried by said pair of slide assemblies; and
a pressure washer unit mounted on the tray floor whereby said pressure washer unit can be accessed through said compartment opening, slid out for use and returned to its stowed position within the side of said carriage for transportation after use.
